(19) United States
(12) Patent Application Publication
(10) Pub. No.: US 2021/0364991 A1
(43) Pub. Date: Nov. 25, 2021

(54) DIGITALLY-CONTROLLED ANALOG ART CLOCKS AND VERTICAL CLOCKS

(71) Applicants: Howard O. McMillan, IV, Lithia, FL (US); Trent O. McMillan, Lithia, FL (US)

(72) Inventors: Howard O. McMillan, IV, Lithia, FL (US); Trent O. McMillan, Lithia, FL (US)

(21) Appl. No.: 17/324,916

(22) Filed: May 19, 2021

Related U.S. Application Data
(60) Provisional application No. 63/027,944, filed on May 20, 2020.

(51) Int. Cl. G04C 3/14; G04B 19/04; G04B 45/00; G04D 7/00

(52) U.S. Cl. CPC G04C 3/146; G04D 7/00; G04B 45/0084; G04B 19/04

(57) ABSTRACT

Digital/analog art clocks and vertical clocks are described.

### RELATED APPLICATIONS

This application claims the benefit of U.S. Provisional Application No. 63/027,944 entitled “Digitally-controlled Analog Art Clocks and Vertical Clocks” and filed on May 20, 2020, which is incorporated herein by reference in its entirety.

### TECHNICAL FIELD

Some implementations relate generally to digitally controlled analog clocks and, more particularly, to a clock in which the hour and minute hands move in a linear direction horizontally or vertically.

### BACKGROUND

The clock is one of the oldest inventions, meeting the need to measure intervals of time shorter than the natural units such as the day, the lunar month, and the year. Devices operating on several physical processes have been used over the millennia. The first mechanical clocks were developed around 1300 in Europe, which kept time with oscillating timekeepers like balance wheels. The next development in accuracy occurred after 1656 with the invention of the pendulum clock. The electric clock with rotating hands has been around since about the 1840's.

Clocks have different ways of displaying the time. Analog clocks indicate time with a traditional clock face and rotating hands. Digital clocks display a numeric representation of time. Two numbering systems are in use: 24-hour time notation and 12-hour notation. Most digital clocks use electronic mechanisms and LCD, LED, or VFD displays.

Embodiments were conceived to address the above-mentioned limitations of conventional clocks among other things.

### SUMMARY

Some implementations can include a Digital Analog Art Clock. The Digital Analog Art Clock provides a visual indication of time by moving the minute and hour hands via stepper motors in a linear horizontal or vertical direction across artwork. Some implementations can include vertical clocks in which time is displayed on two or more vertical elements. A clock comprising a body, wherein the body can have various sizes and shapes, wherein the body can have a decorative cover portion such as artwork. The clock includes an hour hand, wherein the hour hand can have various sizes and shapes, wherein the hour hand can move on a horizontal axis or vertical axis via a stepper motor. The clock also includes a minute hand, wherein the minute hand can have various sizes and shapes, wherein the minute hand can move on a horizontal axis or vertical axis via a stepper motor. The clock further includes a control circuit, including a processor, a stepper motor driver board, a first and second stepper motor, wherein first stepper motor is attached to the hour hand and the second stepper motor is attached to the minute hand, where in the processor receives the initial time from a network and moves the first and second stepper motor to the current time position, wherein the processor then starts polling the time and continues to update the minute hand and hour hand.

Some implementations can include a set of hour hand calibration switches, and a set of minute hand calibration switches wherein the switches are used to calibrate the scale of the body.

Some implementations can include a clock having a body, wherein the body can have various sizes and shapes, wherein the body can have a decorative cover portion such as artwork. The clock includes a first indicator, wherein the first indicator can have various sizes and shapes, wherein the first indicator can move in a linear direction, wherein the first indicator's position represents a point in time. The clock also includes a second indicator, wherein the second indicator can have various sizes and shapes, wherein the second indicator can move in a linear direction, wherein the second indicator's position represents a point in time. The clock further includes a third indicator, wherein the third indicator can have various sizes and shapes, wherein the third indicator can move in a linear direction, wherein the third indicator's position represents a point in time.

Some implementations can include a set of first indicator calibration switches, a set of second indicator calibration switches, and a set of third indicator calibration switches, wherein the switches are used to calibrate the scale of the body.

### BRIEF DESCRIPTION OF THE DRAWINGS

FIG. 1 is a diagram of a front view of an example Digital Analog Art Clock with horizontal and vertical movement in accordance with some implementations.

FIG. 2 is a diagram of a front view of an example Digital Analog Art Clock with horizontal and vertical movement in accordance with some implementations.

FIG. 3 is a diagram of a front view of an example vertical clock in accordance with some implementations.

FIG. 4 is a diagram of a front view of an example vertical clock in accordance with some implementations.

FIG. 5 is a diagram of a perspective view of an example vertical clock in accordance with some implementations.

FIG. 6 is a diagram of a front view of an example folding vertical clock in accordance with some implementations.

FIG. 7 is a diagram of a back-perspective view of an example folding vertical clock in accordance with some implementations.

FIG. 8 is a diagram of a front view of an example triangular shaped vertical clock in accordance with some implementations.

FIG. 9 is a diagram of a back-perspective view of an example Digital Analog Art Clock with vertical movement in accordance with some implementations.

FIG. 10 is a diagram of a software flow chart view of an example Digital Analog Art Clock or vertical clock control circuit in accordance with some implementations.

FIG. 11 is a diagram of a hardware flow chart view of an example Digital Analog Art Clock or vertical control circuit in accordance with some implementations.

FIG. 12 is a diagram of a front view of an example mobile phone vertical clock graphical user interface in accordance with some implementations.

### DETAILED DESCRIPTION

Some implementations can include a Digital Analog Art Clock. The Digital Analog Art Clock provides a visual indication of the time by moving the minute and hour hands via stepper motors in a linear horizontal or vertical direction across artwork.

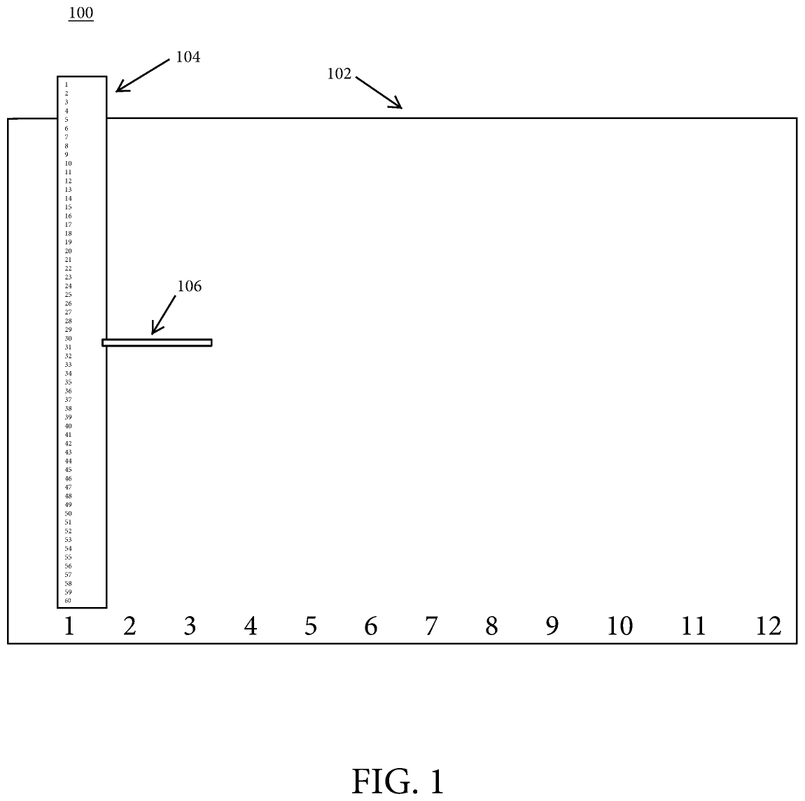

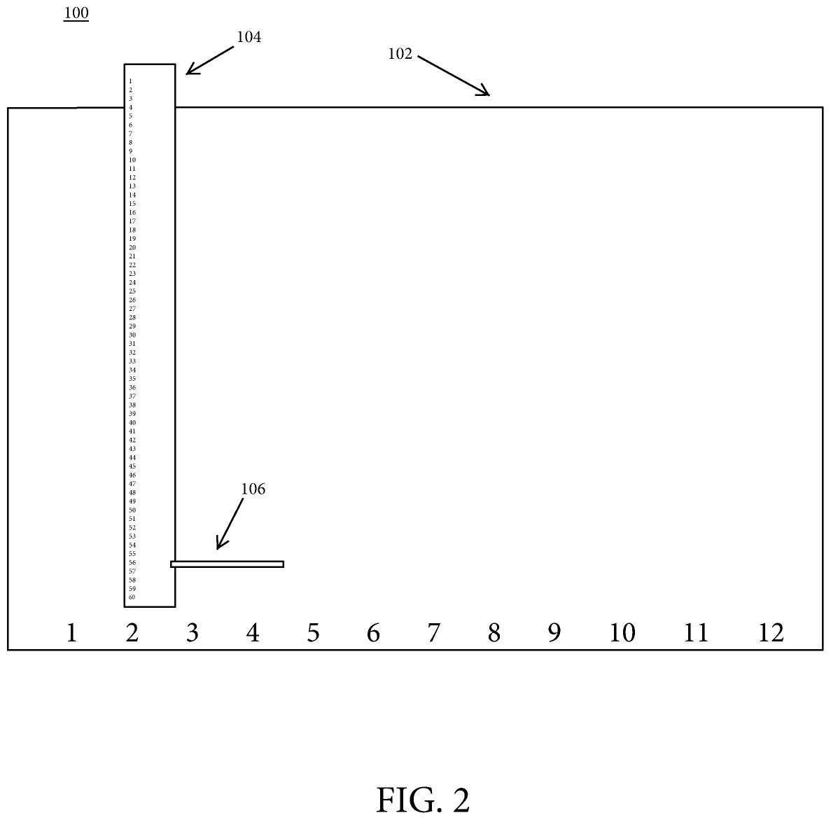

FIGS. 1-2 are diagrams of an example Digital Analog Art Clock 100 with horizontal and vertical movement in accordance with some implementations. The Digital Analog Art Clock 100 includes a background 102 (or body), which can include a first artwork or design, and a second moving artwork or design 104. Movement of the second artwork 104 horizontally across the first artwork 102 can indicate the hour. An indicator hand 106 moves vertically along the second artwork 104 to indicate the minutes,

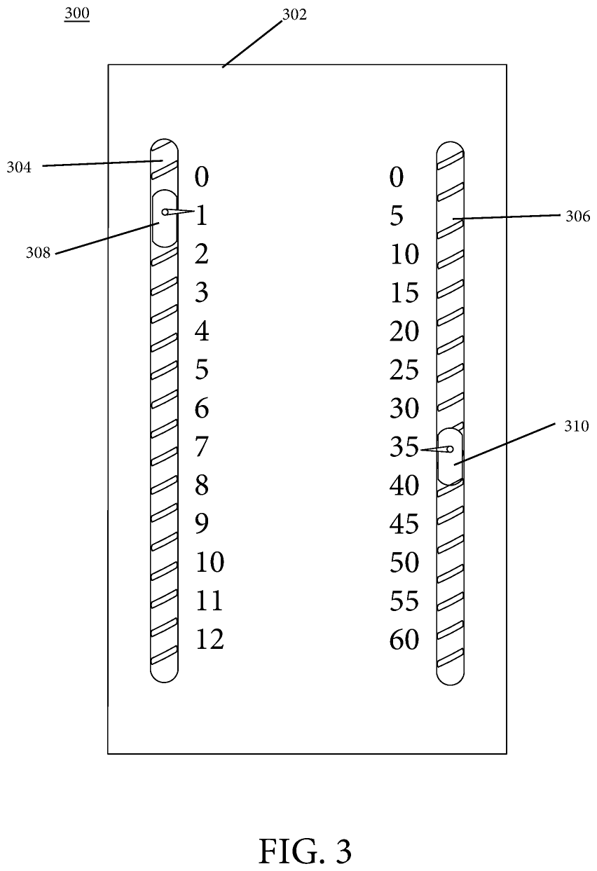

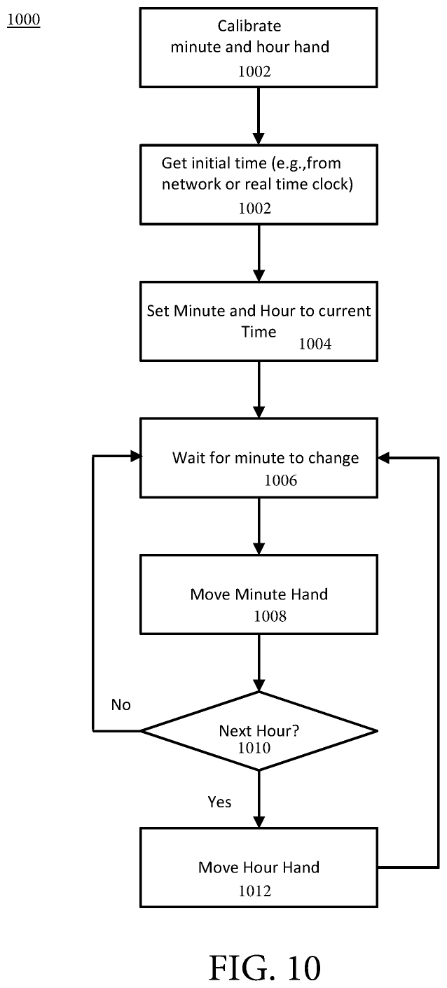

FIG. 3 is a diagram of an example vertical clock 300 with dual vertical movements in accordance with some implementations. The vertical clock 300 includes a body 302, a first exposed worm gear 304 (e.g., for hours), a second exposed worm gear 306 (e.g., for minutes), a first traveling indicator hand 308 and a second travelling indicator hand 310. In operation, a controller (not shown) similar to FIGS. 10-1.1 can control individual motors to drive the worm gears (304 and 306) to cause the traveling indicators (308 and 310) to indicate the time,

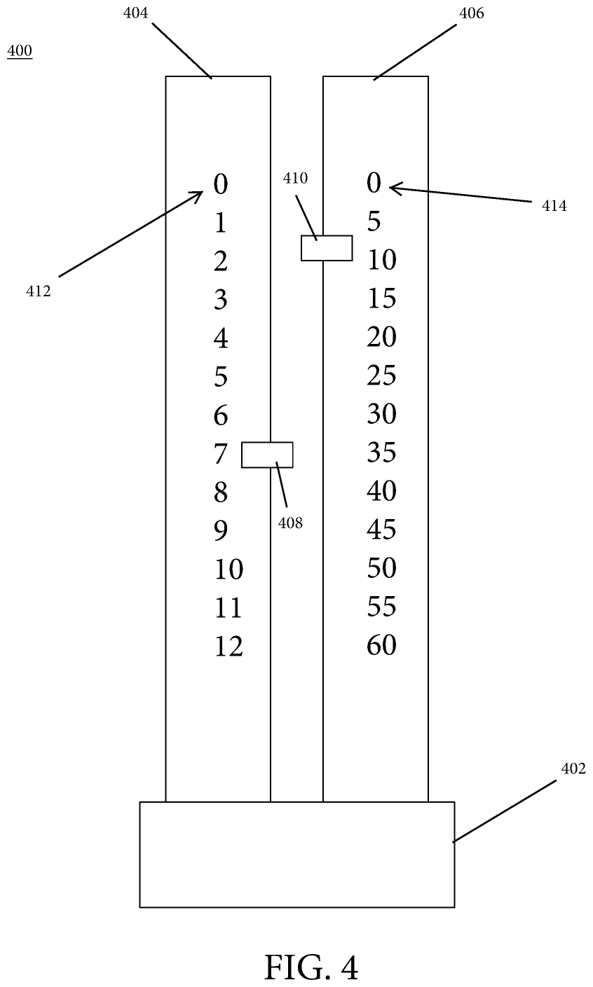

FIG. 4 is a diagram of a front view of an example vertical clock 400 with dual vertical movements in accordance with some implementations. The vertical clock 400 includes a base 402, a first cylindrical element 404, a second cylindrical element 406, a first traveling indicator 408, a second traveling indicator 410, first indicia 412 (e.g., hours), and second indicia 414 (e.g., minutes). The vertical clock 400 operates in a manner similar to vertical clock 300 described above.

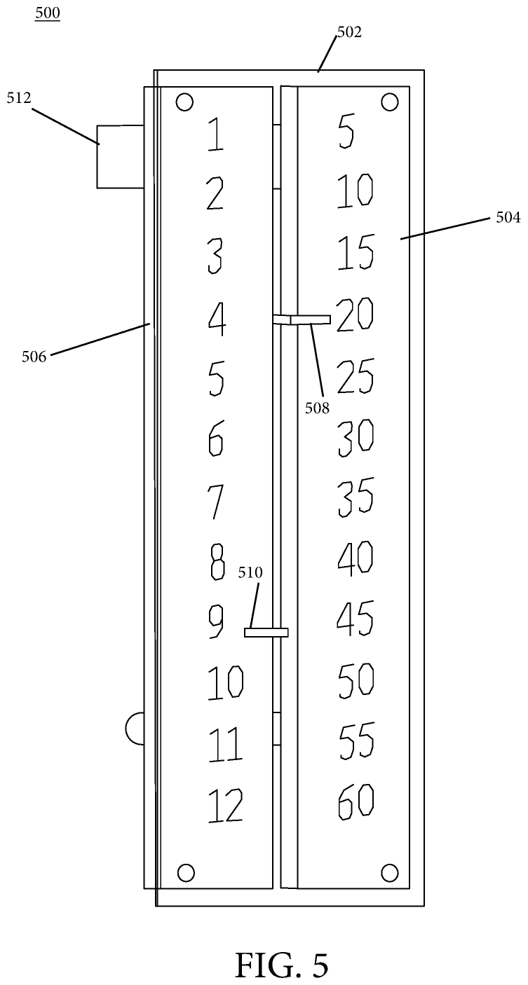

FIG. 5 are diagrams of an example vertical clock 500 with visible mechanics and dual vertical movement in accordance with some implementations. The vertical clock 500 includes a body 502, a first indicia element 504, a second indicia element 506, a first traveling indicator 508 and a second traveling indicator 510.

The vertical clock 500 can also include a mounting bracket 512.

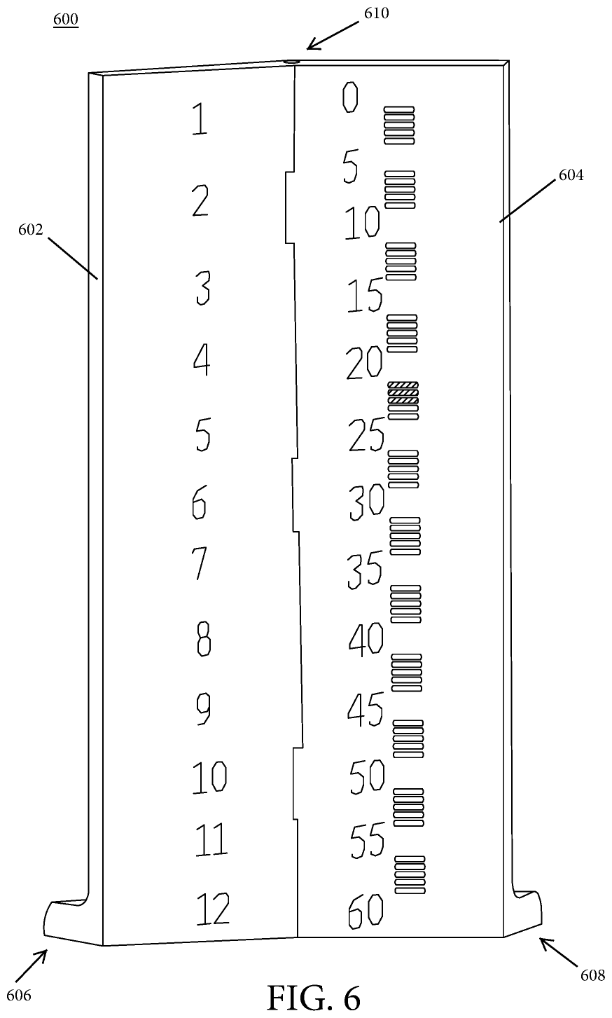

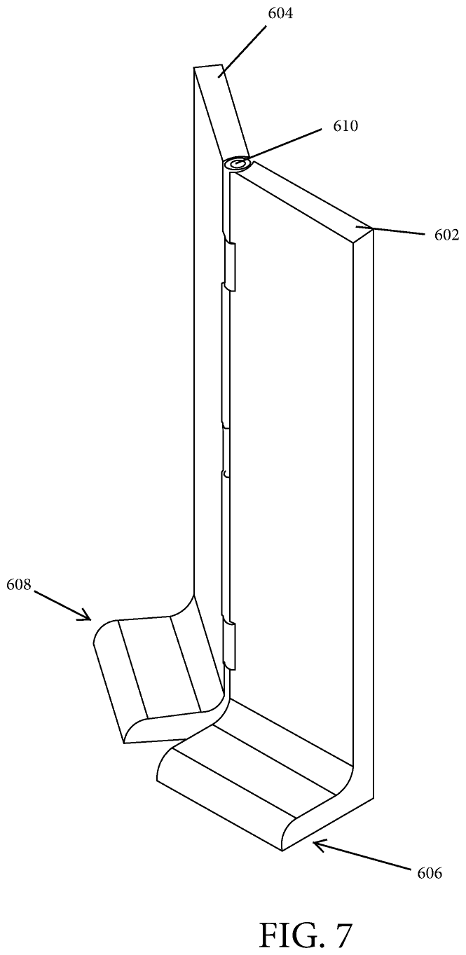

FIGS. 6-7 are diagrams of a front view of an example folding vertical clock 600 with dual vertical movement in accordance with some implementations. The vertical clock 600 includes a first side 602 (e.g., hours), a second side 604 (e.g., minutes), a first base 606, a second base 608, and a hinge 610 joining the first side 602 and the second side 604. Each side includes indicia (e.g., hour or minute numbers or other numbers, letters, or symbols) that are translucent such that a light source illuminated behind the front surface of the two sides causes an indicium (e.g., number) corresponding to the time to illuminate.

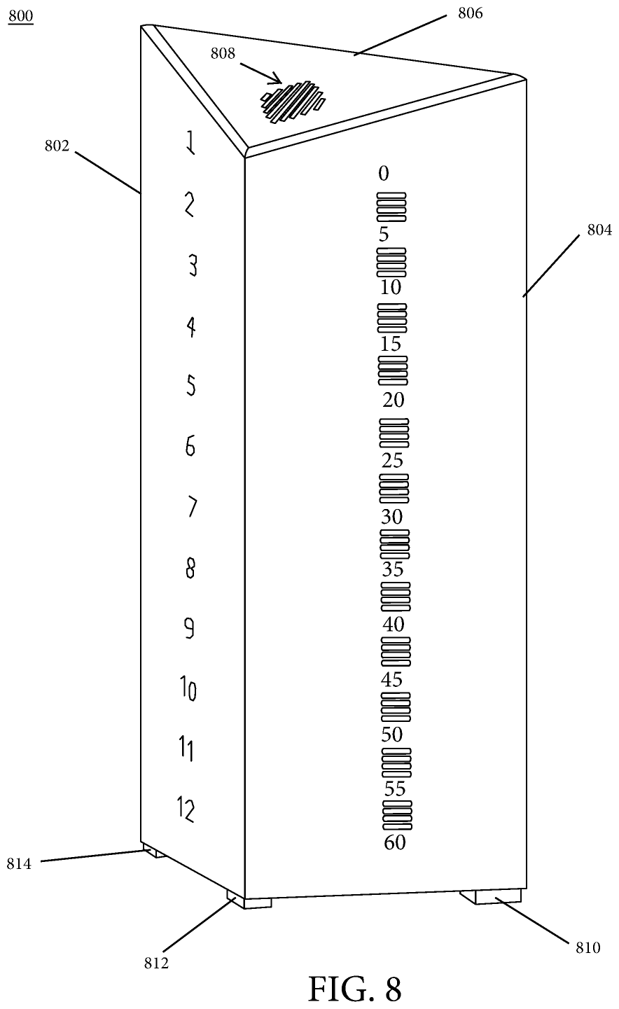

FIG. 8 is a diagram of an example triangular shaped vertical clock 800 with dual vertical movement in accordance with some implementations. The vertical clock 800 includes a first side 802, a second side 804, a top side 806, a speaker grill 808, a first foot 810, a second foot 812, and a third foot 814. The first and second side (802, 804) includes indicia (e.g., hour or minute numbers or other numbers, letters, or symbols) that are translucent such that a light source illuminated behind the front surface of the two skies causes an indicium (e.g., number) corresponding to the time to illuminate. The vertical clock 800 can also include a processor, a communications section, and a speaker to provide smart speaker functionality.

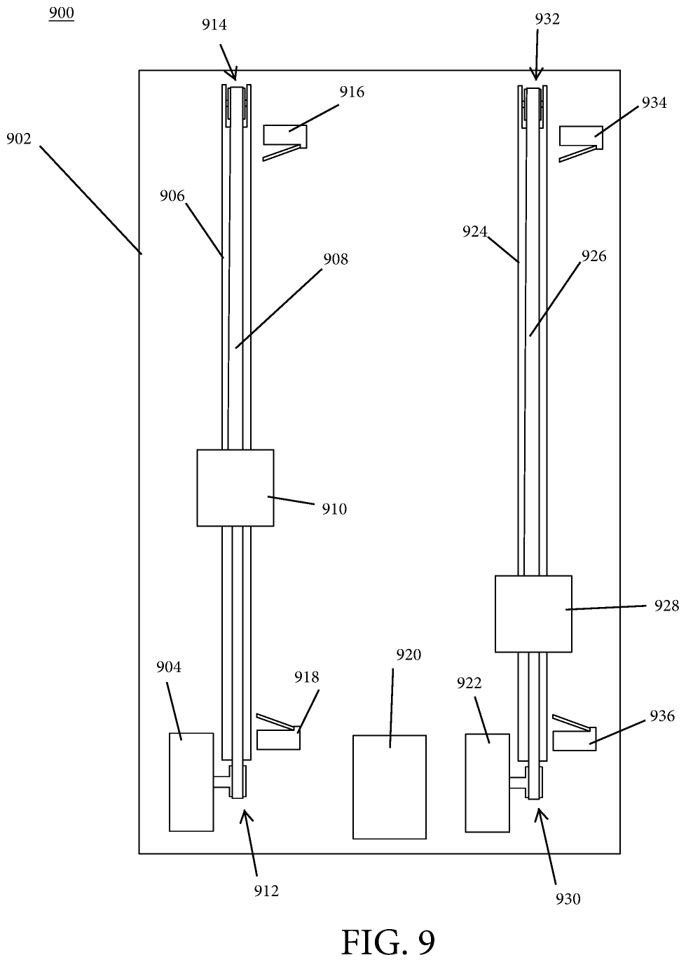

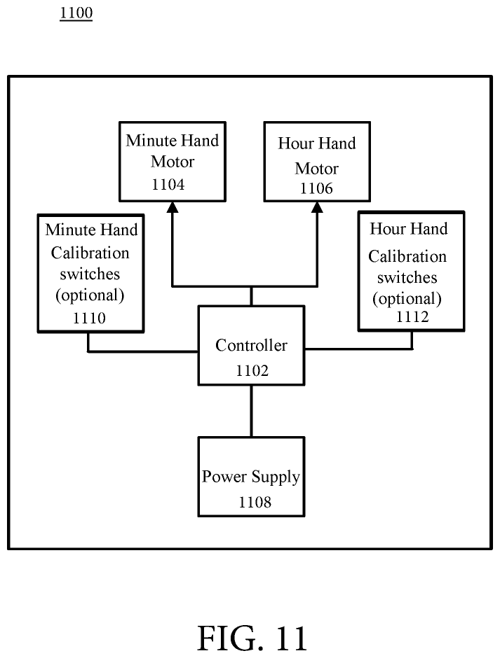

FIG. 9 is a diagram of a back-perspective view of an example Digital Analog Art Clock with vertical movement in accordance with some implementations. The Digital Analog Art Clock 900 includes a body 902, a minute hand motor 904 (e.g., servo), a minute hand track 906, a minute hand belt 908, a minute traveling indicator hand 910, a minute hand gear 912, a minute hand idler pulley 914, a first minute hand calibration switch 916, a second minute hand calibration switch 918, a controller section 920 (e.g., similar FIG. 11), an hour hand motor 922 (e.g., servo), an hour hand track 924, an hour hand belt 926, an hour traveling indicator hand 928, an hour hand gear 930 an hour hand idler pulley 932, a first hour hand calibration switch 934, and a second hour hand calibration switch 936.

The first and second hour hand calibration switches (934. 936), and the first and second minute hand calibration switches (916. 918) are optional, but when installed permits the same code to be used for all clocks no matter the size and/or scale of the clock. The controller measures the distance from the first and second minute hand calibration switches and determines the scale of minute time subdivisions. The controller also measures the distance from the first and second hour hand calibration switches and determines the scale of the hours. The indicia (e.g., hour or minute numbers or other numbers, letters, or symbols) can now be placed on the body of the clock accordingly.

In some implementations the Digital Analog Art Clock could have a third linear measurement used to indicate the seconds.

In some implementations the Digital Analog Art Clock can use belts and tracks to move the minute and hour hands in a manner similar to that described above, but a number of alternative mechanical components could be used (e.g., worm gears, pulleys system). Some implementations can include a mechanical drive system including chains, weights, and/or pendulums that is similar in construction and operation as a traditional grandfather clock with the difference being that the mechanism is used to drive the linear motion of the hands of the disclosed clocks.

FIG. 10 is a diagram of a software flow chart view of an example Digital Analog Art Clock or vertical clock control circuit in accordance with some implementations. Processing begins at 1002 with calibrating the minute and hour hand. For example, a calibration process can include moving the minute or hour hand from a first stop point to a second stop point, determining the distance between the two points in terms of motor control parameters, dividing the distance by the number of subdivisions (e.g., 12 hours or 60 minutes), storing the result of the division and returning the hand to a start point or the current time point based on the stored value. The calibration process can be performed for each of the hands such as hour hand, minute hand and/or second hand (if present). Calibration can also be performed if other indicator hands are present in an implementation such as time in another time zone, moon phase, date, etc. Processing continues to 1004.

At 1004 control circuit obtains an initial time (e.g., from a real time clock or network such as wi-fi, etc.) and stores the current time. Processing continues to 1006.

At 1006, minute and hour indicators are set to the current time. For example, servo motors may be activated to move travelling indicators to location indicating the current time. In another example, light may be illuminated to indicate the current time. Processing continues to 1008.

At 1008, polling the real time clock or network such as wi-fi, etc. for time to change. Processing continues to 1010.

At 1010, the minute hand is moved (or the minute light is illuminated) corresponding to the current minute. Processing continues to 1012.

At 1012, the control circuit determines if it is the next hour yet. If so, processing continues to 1014. Otherwise, processing continues to 1008.

At 1014, the hour indicator is moved to the current hour (or light illuminated for the current hour). Processing continues to 1008.

FIG. 11 is a diagram of an example Digital Analog Art Clock or vertical clock control circuit 1100 in accordance with some implementations. The control circuit 1100 includes a controller (e.g., a processor or dedicated electronic circuit), a minute hand motor 1104, a n hour hand motor 1106, and a power supply 1108 (e.g., a battery, USB power adapter, or AC power adapter, etc.) a set of minute hand calibration switches 1110 (optional), and a set of hour hand calibration switches 1112 (optional).

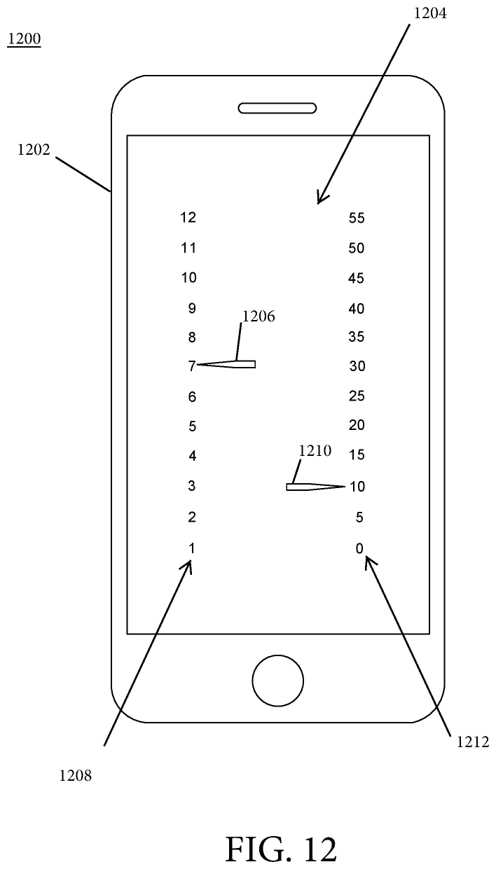

FIG. 12 is a diagram of a front view of an example mobile phone vertical clock graphical user interface (GUI) in accordance with some implementations. The vertical clock GUI 1200 is displayed on a display of a mobile device 1202 and can include optionally a background 1204 (or artwork), a first indicator hand 1206 moves vertically along a second artwork 1208 to indicate the hours. A second indicator hand 1210 moves vertically along a third artwork 1212 to indicate the minutes.

In some implementations the vertical clock GUI 1200 could include a third vertical indicator had moving vertically along a fourth artwork to indicate the seconds.

It is, therefore, apparent that there is provided, in accordance with the various embodiments disclosed herein, Digital Analog Art Clocks and vertical clocks.

While the disclosed subject matter has been described in conjunction with a number of embodiments, it is evident that many alternatives, modifications and variations would be, or are, apparent to those of ordinary skill in the applicable arts. Accordingly, Applicants intend to embrace all such alternatives, modifications, equivalents and variations that are within the spirit and scope of the disclosed subject matter.

What is claimed is:

1. A clock comprising:
a body, wherein the body can have various sizes and shapes, wherein the body can have a decorative cover portion such as artwork;
an hour hand, wherein the hour hand can have various sizes and shapes, wherein the hour hand can move on a horizontal axis or vertical axis via a stepper motor;
a minute hand, wherein the minute hand can have various sizes and shapes, wherein the minute hand can move on a horizontal axis or vertical axis via a stepper motor; and
a control circuit, including a processor, a stepper motor driver board, a first and second stepper motor, wherein first stepper motor is attached to the hour hand and the second stepper motor is attached to the minute hand, wherein the processor receives an initial time from a network and moves the first and second stepper motors to a current time position based on the initial time, wherein the processor then starts polling the time and updates the minute hand and hour hand positions respectively as the time changes.

2. The clock of claim 1, further comprising a set of hour hand calibration switches, and a set of minute hand calibration switches wherein the switches are used to calibrate a scale of the body.

3. A clock comprising:
a body, wherein the body can have various sizes and shapes, wherein the body can have a decorative cover portion such as artwork;
an hour hand, wherein the hour hand can have various sizes and shapes, wherein the hour hand can move on a vertical axis via a stepper motor;
a minute hand, wherein the minute hand can have various sizes and shapes, wherein the minute hand can move on a vertical axis via a stepper motor; and
a control circuit, including a processor, a stepper motor driver board, a first and second stepper motor, wherein first stepper motor is attached to the hour hand and the second stepper motor is attached to the minute hand, where in the processor receives an initial time from a network and moves the first and second stepper motor to a current time position based on the initial time, wherein the processor then starts polling the time and continues to update the minute hand and hour hand based on changes in time.

4. The clock of claim 3, further comprising a set of hour hand calibration switches, and a set of minute hand calibration switches, wherein the switches are used to calibrate a scale of the body.

5. A clock comprising:
a body, wherein the body can have various sizes and shapes, wherein the body can have a decorative cover portion such as artwork;
a first indicator, wherein the first indicator can have various sizes and shapes, wherein the first indicator can move in a linear direction, wherein position of the first indicator represents a point in time for a first unit of time; and
a second indicator, wherein the second indicator can have various sizes and shapes, wherein the second indicator can move in a linear direction, wherein position of the second indicator represents a point in time for a second unit of time.

6. The clock of claim 5, further comprising a set of first indicator calibration switches, and a set of second indicator calibration switches, wherein the switches are used to calibrate a scale of the body.

7. A clock comprising:
a body, wherein the body can have various sizes and shapes, wherein the body can have a decorative cover portion such as artwork;
a first indicator, wherein the first indicator can have various sizes and shapes, wherein the first indicator can move in a linear direction, wherein position of the first indicator represents a point in time of a first unit of time;
a second indicator, wherein the second indicator can have various sizes and shapes, wherein the second indicator can move in a linear direction, wherein position of the second indicator represents a point in time of a second unit of time; and
a third indicator, wherein the third indicator can have various sizes and shapes, wherein the third indicator can move in a linear direction, wherein position of the third indicator represents a point in time of a third unit of time.

8. The clock of claim 7, further comprising a set of first indicator calibration switches, a set of second indicator calibration switches, and a set of third indicator calibration switches, wherein the switches are used to calibrate a scale of the body.
